(19) United States
(12) Patent Application Publication
(10) Pub. No.: US 2007/0039408 A1
(43) Pub. Date: Feb. 22, 2007

(54) Plastic handguard

(76) Inventors: Kenneth T. Laivins, Hebron, OH (US); Glen Arthur Laivins, Hebron, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 11/204,654

(22) Filed: Aug. 16, 2005

(51) Int. Cl. B62K 21/12

(52) U.S. Cl. 74/551.8

(57) ABSTRACT

A handguard configured to be attached to a handlebar of a vehicle is disclosed herein. In one embodiment of the application, the handguard includes an arm portion, a shield portion, and a support member. The support member has a shape that corresponds to at least a section of the arm portion and is removably attached to the arm portion. In one embodiment, the arm portion and the shield portion may be part of a unitary member constructed of plastic.

### FIELD OF INVENTION

The present application relates to a handguard for a handlebar. In particular, the present application relates to a handguard for a handlebar of a vehicle, such as a bicycle, motorcycle, motor scooter, motorbike, or all-terrain vehicle (“ATV”).

### BACKGROUND

Handguards for protecting the hands of riders of bicycles, motorcycles, motor scooters, motorbikes, and ATVs are known in the art. In one known embodiment, a handguard is constructed of separate arm and shield components. The arm is configured to be attached to a handlebar and the shield component is configured to be attached to the arm in front of the handlebar. The shield thus protects a rider's hands from wind and debris.

### BRIEF DESCRIPTION OF THE DRAWINGS

In the accompanying drawings, structures are illustrated that, together with the detailed description provided below, describe exemplary embodiments of the claimed invention.

In the drawings and description that follows, like elements are identified with the same reference numerals. The drawings are not to scale and the proportion of certain elements may be exaggerated for the purpose of illustration.

FIG. 1 is a simplified perspective view of one embodiment of a handguard 100 disposed on a motorcycle M;

FIG. 2 is a simplified perspective view of one embodiment of a handguard 100;

FIG. 3 is a simplified top plan view of one embodiment of a handguard 100;

FIG. 4 is a simplified side plan view of one embodiment of the handguard 100;

FIG. 5 is a simplified side plan view of one embodiment of the handguard 100 having a support member 160; and

FIG. 6 is a simplified top view of one embodiment of the handguard 100 with a support member 160 removed; and

FIG. 7 is a simplified perspective view of one embodiment of a handguard 100 having a rubber lining 200.

### DETAILED DESCRIPTION

The present application is directed to a plastic handguard for a handlebar of a vehicle, such as a motorcycle, a motorbike, a motor scooter, a bicycle, or an ATV. The handguard may be employed to protect a rider's hand from wind, rain, and debris.

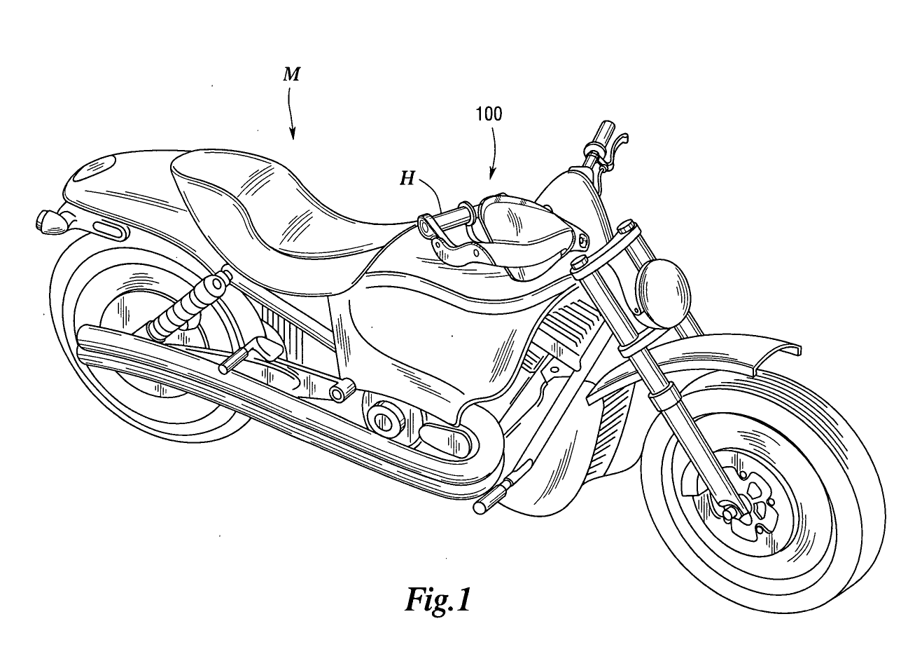

FIG. 1 illustrates a simplified perspective view of one embodiment of a handguard 100 mounted on a handlebar H of a motorcycle M. In this embodiment, the handguard 100 is positioned in front of the handlebar H to protect a rider's hand. In alternative embodiments, the handguard 100 may be employed on a motorbike, motor scooter, bicycle, ATV, or any other vehicle having handlebars.

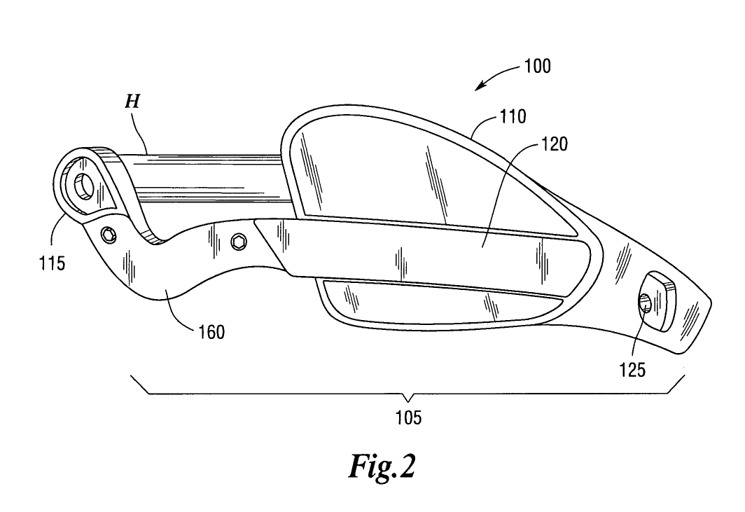

FIG. 2 illustrates a simplified perspective view of one embodiment of a handguard 100. The handguard 100 includes a unitary member 105 having a shield portion 110 and an arm portion 115. In an alternative embodiment (not shown), the handguard 100 is comprised of a separate arm and shield.

The unitary member 105 may be constructed of a variety of polymeric materials, including, without limitation, polypropylene, polyethylene, ethylene propylene diene monomer (EPDM) rubber, or a combination thereof. In one embodiment, the unitary member 105 is constructed of 10% polypropylene, 0% polyethylene, and 90% EPDM rubber. In another embodiment, the unitary member 105 is constructed of 0% polypropylene, 0% polyethylene, and 100% EPDM rubber. Polypropylene provides stiffness to the unitary member 105, while polyethylene provides resilience and EPDM rubber provides flexibility.

Since the unitary member 105 is constructed of a polymeric material, the unitary member 105 can be molded to include complex features and to facilitate installation on a handlebar H. Furthermore, a polymeric material can flex to the shape of a handlebar H, allowing the unitary member 105 to be attached to handlebars of different shapes and sizes. Additionally, the use of a polymeric material allows the unitary member 105 to absorb impacts and retain its shape.

With continued reference to FIG. 2, the shield portion 110 has a concave shape configured to protect a rider's hand in multiple directions. Further, the shield portion 110 includes a rib 120 to provide support. In alternative embodiments (not shown), additional ribs may be employed to provide extra support.

In one embodiment, the shield portion 110 includes an aperture 125 configured to receive a fastener (not shown) to attach the shield portion 110 to a handlebar H. Exemplary fasteners include, without limitation, screws, bolts, ties, or any other appropriate fastening devices. The fastener may be attached directly or indirectly to the handlebar H. In one embodiment (not shown), the fastener is a bolt that attaches the shield portion 110 to a clamp. The clamp, in turn, is configured to be attached to the handlebar H. In an alternative embodiment (not shown), the shield portion 110 includes a unitary clamp or other fastening member.

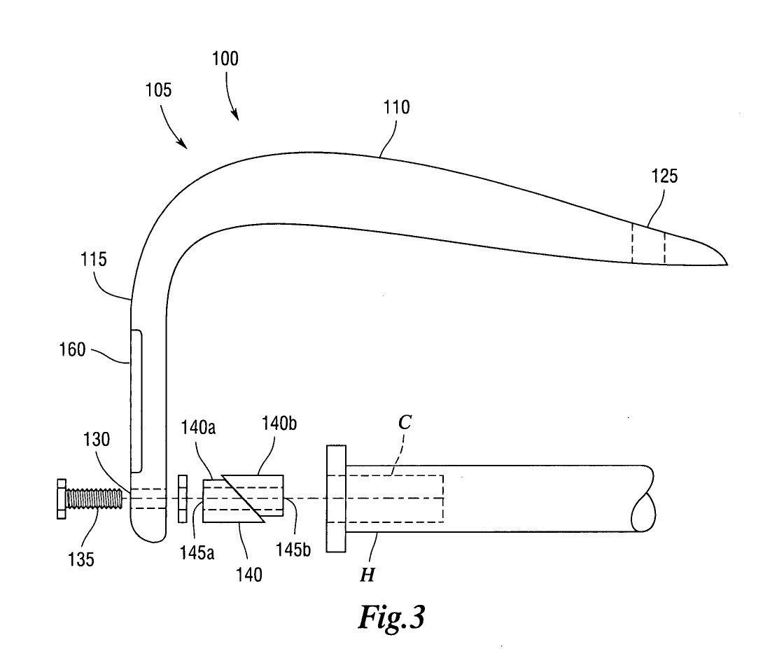

FIG. 3 illustrates a simplified top plan view of the handguard 100. As shown in the illustrated embodiment, the unitary member 105 is generally L-shaped, such that the shield portion 110 forms a major segment of the “L” and the arm portion 115 forms a minor segment. The shield portion 110 is oriented at an angle A with respect to the arm portion 115, wherein angle A is chosen such that the shield portion 110 is at an optimal distance from the handlebar H. The shield portion 110 should be close enough to the handlebar H to maximize protection of a rider's hands, yet far enough away from the handlebar H to allow a rider to quickly remove his hands if necessary. In one embodiment, angle A is between 70-75°. In the illustrated embodiment, angle A is approximately 71°. In an alternative embodiment (not shown), the shield portion 110 is substantially perpendicular to the arm portion 115.

With continued reference to FIG. 3, the arm portion 115 includes an aperture 130 configured to receive a fastener 135 to attach the arm portion 115 to a handlebar H. Exemplary fasteners include, without limitation, screws, bolts, ties, or any other appropriate fastening devices. The fastener 135 may be attached directly or indirectly to the handlebar H. In the illustrated embodiment, the fastener 135 is a screw that attaches the arm portion 115 to a bar 140 having a channel 145.

In one embodiment, the bar 140 is constructed of two separate bar components 140a,b, wherein bar component 140a has a smooth channel 145a and bar component 140b has a threaded channel 145b. The bar components 140a,b have complementary angled ends that are offset such that when the screw is fastened to the threaded channel 145b, bar component 140a flares outwards, thereby creating a friction fit inside a cavity C of handlebar H. In one embodiment, the bar 140 is constructed of an alloy material, such as aluminum. In an alternative embodiment, the bar may be constructed of rubber.

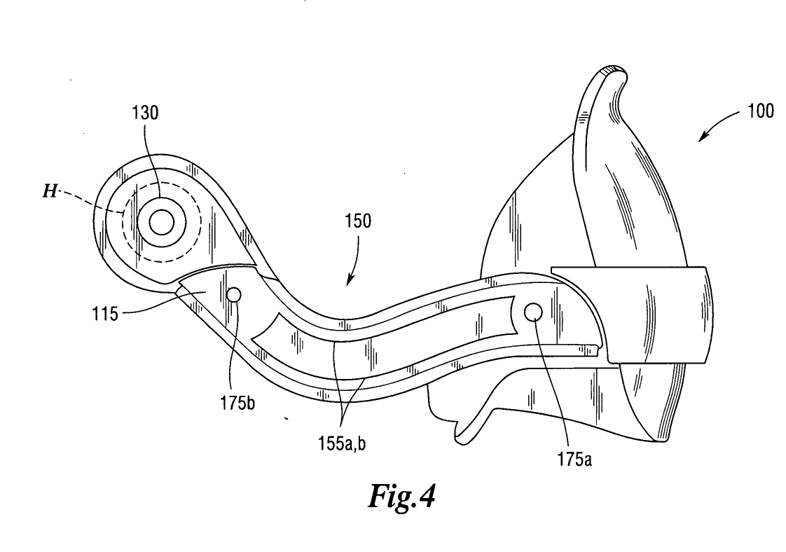

FIG. 4 illustrates a simplified side view of the handguard 100. The arm portion 115 is configured with a V-shaped bend 150, as shown. In other words, if the top view is taken to be an X-Y plane, the arm portion is bent in a Z direction. In this configuration, at least a portion of the arm portion extends below the handlebar H, allowing a rider to quickly remove his hand from the handlebar H if necessary.

With continued reference to FIG. 4, the arm portion 115 includes two ribs 155a,b to provide support. In alternative embodiments (not shown), more than two ribs may be employed to provide extra support.

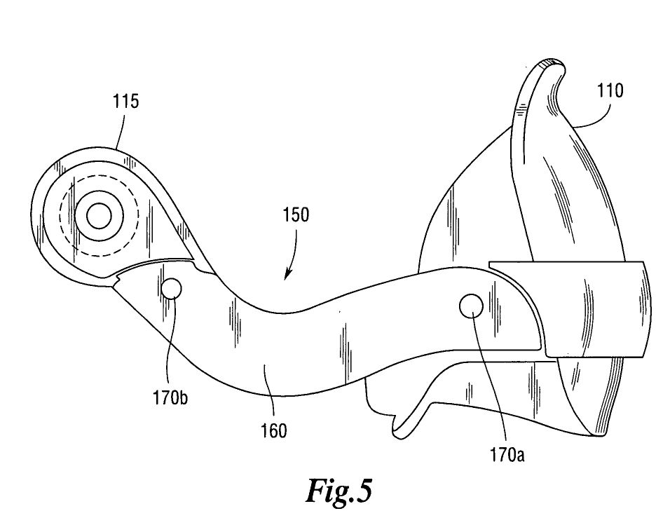

FIG. 5 illustrates a simplified side view of one embodiment of the handguard 100 having a support member 160 attached to an exterior side of the arm portion 115. The support member 160 has a shape that corresponds to a shape of at least a section of the arm portion 115. The support member 160 is configured to provide support for the arm portion 115 and serves as an arm cover configured to cover the ribs 155a,b of the arm portion 115. In an alternative embodiment (not shown), the support member 160 can be attached to an interior side of the arm portion 115.

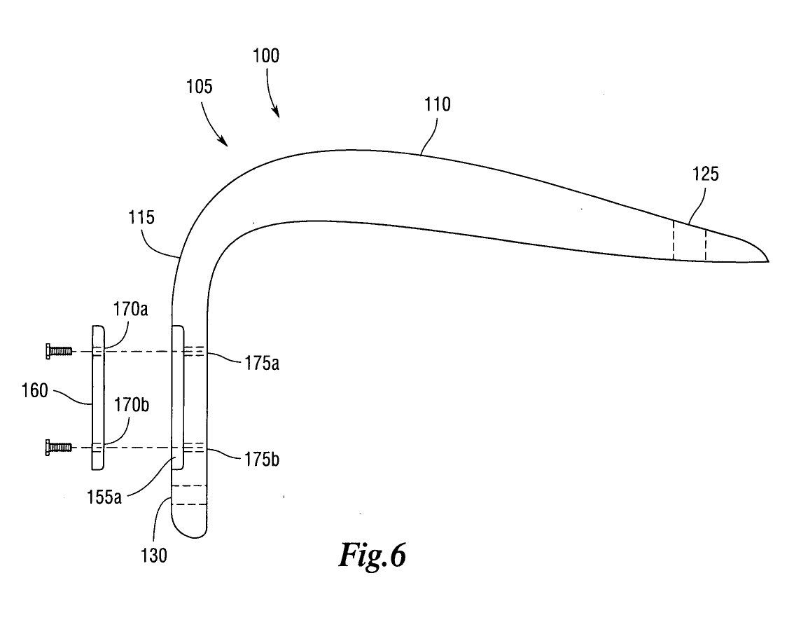

FIG. 6 illustrates a simplified top view of one embodiment of the handguard 100 with a support member 160 removed. The support member 160 is removably attached to the arm portion 115, so that worn or damaged support members can be replaced.

As shown in FIG. 6, the support member 160 is attached to the arm portion 115 via fasteners, such as screws 165. Exemplary fasteners include, without limitation, screws, bolts, ties, or other appropriate fastening devices. To accommodate screws 165, the support member 160 has two apertures 170a,b, while the arm portion 115 has two corresponding threaded channels 175a,b. In an alternative embodiment (not shown), the arm portion 115 may have corresponding threaded metal inserts molded therein. In yet another embodiment (not shown), the support member 160 and the arm portion 115 have corresponding structures such that the support member 160 can be “snapped” into place.

In one embodiment, the support member 160 is constructed of the same material as the unitary member 105. In an alternative embodiment, the support member 170 is constructed of a different material than the unitary member 105 to provide different levels of strength. The support member 160 may be constructed of metal or a variety of polymeric materials, including, without limitation polypropylene, polyethylene, EPDM rubber, or a combination thereof. In one embodiment, the support member 160 is constructed of 100% polypropylene, 0% polyethylene, and 0% EPDM rubber. In another embodiment, the support member 160 is constructed of 0% polypropylene, 50% polyethylene, and 50% EPDM rubber.

In one embodiment, support members of different colors can be made available, so that a rider may replace a support member of one color with a support member having a color of his preference. Additionally, the support members may have different logos.

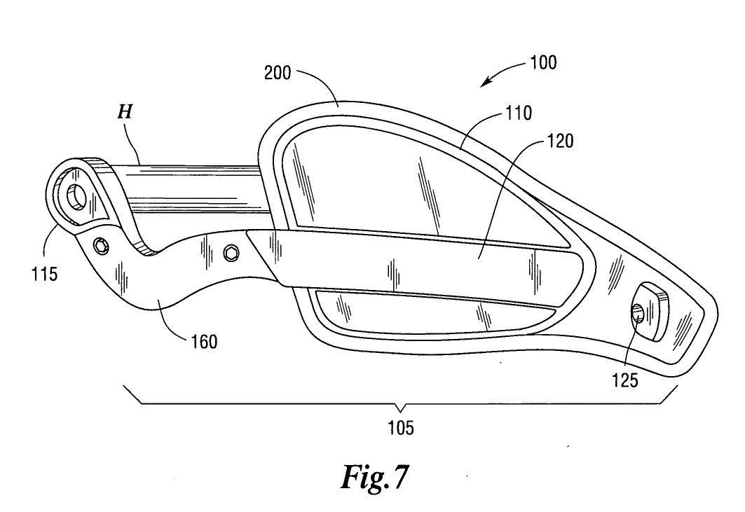

FIG. 7 illustrates a simplified perspective view of another embodiment of a handguard 100. In the illustrated embodiment, the shield portion 110 is configured to receive a removable rubber lining 200 along its perimeter. The removable rubber lining 200 covers the exposed edges of the shield portion 110 to protect a rider from injury in case of an accident and to protect the shield from damage. In an alternative embodiment (not shown), the removable rubber lining 200 only covers a portion of the exposed edges of the shield portion 110. In another alternative embodiment, the rubber lining 200 is not removable, but is integrated with the shield portion 110.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

1. A handguard comprising:
a unitary member having a shield portion and an arm portion, wherein the arm portion is oriented at an acute angle with respect to the shield portion in an X-Y plane and is bent in a Z-direction; and
an arm cover removably attached to at least a section of the arm portion.

2. The handguard of claim 1, wherein the arm portion is configured to receive a fastening member.

3. The handguard of claim 1, wherein the shield portion is configured to receive a fastening member.

4. The handguard of claim 1, wherein the shield portion has a concave shape.

5. The handguard of claim 1, wherein the unitary member is constructed of a polymeric material.

6. The handguard of claim 1, wherein the unitary member is constructed of polypropylene, polyethylene, and ethylene propylene diene monomer rubber, or a combination thereof.

7. The handguard of claim 1, wherein the unitary member and the arm cover are constructed of different material.

8. The handguard of claim 1, wherein the arm cover has a different color from the unitary member.

9. The handguard of claim 1, wherein the arm cover provides support for the arm portion.

10. The handguard of claim 1, wherein the shape of the arm cover substantially corresponds to the section of the arm portion.

11. The handguard of claim 1, wherein the handguard further comprises a removable rubber lining configured to cover at least one edge of the shield portion.

12. A handguard configured to be attached to a handlebar of a vehicle, the handguard comprising:
an arm portion;
a shield portion; and
a support member having a corresponding shape to at least a section of the arm portion and removably attached to an exterior side of at least the section of the arm portion.

13. The handguard of claim 12, wherein the arm portion includes a substantially V-shaped bend such that at least a portion of the arm portion extends below the handlebar.

14. The handguard of claim 12, wherein the arm portion has at least one rib disposed therein.

15. The handguard of claim 12, wherein the arm portion and the shield portion are portions of a unitary member.

16. The handguard of claim 15, wherein the unitary member is generally L-shaped.

17. The handguard of claim 15, wherein the unitary member is constructed of a polymeric material.

18. The handguard of claim 15, wherein the unitary member is constructed of polypropylene, polyethylene, and ethylene propylene diene monomer rubber, or a combination thereof.

19. A generally L-shaped, unitary, handguard constructed of a polymeric material and configured to be attached to a handlebar of a vehicle, the handguard comprising:
a minor segment configured to extend substantially perpendicularly from an end of the handlebar in a forward direction; and
a major segment configured to extend in front of the handlebar.

20. The handguard of claim 19, wherein the generally L-shaped member is constructed of polyethylene, polypropylene, ethylene propylene diene monomer rubber, or a combination thereof.

21. The handguard of claim 19, wherein the minor segment has at least one rib.

22. The handguard of claim 19, wherein the minor segment is adapted to receive a support member.

23. The handguard of claim 19, wherein the minor segment has a V-shaped bend in a downward direction, such that a portion of the minor segment is below the handlebar.

24. The handguard of claim 19, wherein the major segment is configured to form a concave shield.

25. A support member, having a shape corresponding to at least a section of an arm portion of a handguard configured to be attached to a handlebar of a vehicle, wherein the arm portion of the handguard has a V-shaped bend, the support member comprising:
means for attaching the support member to at least a section of the arm portion.

26. The support member of claim 25, wherein the support member is constructed of a different material from the arm portion of the handguard.

27. The support member of claim 25, wherein the support member is a different color from the arm portion of the handguard.
